(19) United States
(12) Patent Application Publication
(10) Pub. No.: US 2024/0118043 A1
(43) Pub. Date: Apr. 11, 2024

(54) RADIATOR SUPPORT UPPER COVER

(71) Applicant: TOYOTA JIDOSHA KABUSHIKI KAISHA, Toyota-shi Aichi-Ken (JP)

(72) Inventors: Takaharu NAGATOSHI, Nissin-shi Aichi-Ken (JP); Hiroki NIWA, Nagoya-shi Aichi-Ken (JP); Haruki MITAMURA, Nissin-shi Aichi-Ken (JP); Shotaro FUJIMORI, Toyota-shi Aichi-Ken (JP); Takahiro IMAEDA, Toyota-shi Aichi-Ken (JP)

(73) Assignee: TOYOTA JIDOSHA KABUSHIKI KAISHA, Toyota-shi Aichi-Ken (JP)

(21) Appl. No.: 18/372,283

(22) Filed: Sep. 25, 2023

(30) Foreign Application Priority Data
Oct. 5, 2022 (JP) 2022-161011

(51) Int. Cl. F28F 9/013; B60K 11/04

(52) U.S. Cl. CPC F28F 9/013; B60K 11/04

(57) ABSTRACT

A radiator support upper cover that covers an upper portion of a radiator is provided over the upper portion of the radiator. The radiator support upper cover includes a front cover member. The upper cover member covers a portion of the upper portion of the radiator on a vehicle front side. The front cover member is provided with a plurality of through holes penetrating the front cover member in a vehicle up-down direction. A through hole located on the vehicle rear side is formed at a position further on an upper side in the vehicle up-down direction than a through hole located on the vehicle front side.

### CROSS REFERENCE TO RELATED APPLICATION

This application claims priority to Japanese Patent Application No. 2022-161011 filed on Oct. 5, 2022, which is incorporated herein by reference in its entirety including the specification, claims, drawings, and abstract.

### TECHNICAL FIELD

The present disclosure relates to a radiator support upper cover that covers the upper portion of a radiator provided in a vehicle.

### BACKGROUND

In general, outside air is taken into an engine compartment from an outside air introduction port of a front grille, and the outside air taken in is supplied to a radiator provided in the engine room of the vehicle to cool the radiator. For example, a radiator support cover that covers the upper portion of the radiator is provided. A plurality of holes for air guide are formed in the radiator support cover, and the outside air taken in is supplied to the radiator through the plurality of holes.

JP 2017-196968 A describes a radiator support cover provided with a plurality of upper side gutter members and a plurality of lower side gutter members. Since the upper side gutter members and the lower side gutter members are alternately arranged along the right-left direction of the vehicle, a vertically long slit is formed along each lower side gutter member and the corresponding upper side gutter member, between the upper side gutter member and the lower side gutter member. As a result, a plurality of vertically long slits are formed along the right-left direction of the vehicle, and the outside air is supplied to the radiator through the plurality of slits.

According to the radiator support cover described in JP 2017-196968 A, since the upper side gutter members and the lower side gutter members are alternately arranged in the right-left direction of the vehicle, it is difficult to see the radiator from the front side of the vehicle through the front grille. However, since the slits serving as gaps are formed between the upper side gutter members and the lower side gutter members, the radiator is seen through the slits from an oblique direction with respect to the front of the vehicle.

An object of the present disclosure is to improve both appearance of a radiator when viewed from the front grille side of a vehicle and performance of cooling the radiator.

### SUMMARY

One aspect of the present disclosure is a radiator support upper cover that covers an upper portion of a radiator, and includes a front cover member that covers a portion of the upper portion of the radiator on a vehicle front side. The front cover member is provided with a plurality of through holes penetrating the front cover member in a vehicle up-down direction. The plurality of through holes are formed to be arranged from the vehicle front side to a vehicle rear side. A through hole located on the vehicle rear side among the plurality of through holes is formed at a position further on an upper side in the vehicle up-down direction than a through hole located on the vehicle front side among the plurality of through holes.

According to the above configuration, outside air taken through a front grille is supplied to the radiator through the plurality of through holes. As a result, the radiator is cooled. A line of sight from the front grille side located on the vehicle front side is blocked by the front cover member. Also, each of the through holes penetrates the front cover member in the vehicle up-down direction, and the through hole located on the vehicle rear side is formed at the position further on the upper side than the through hole located on the vehicle front side. Therefore, it is difficult for the line of sight from the front grille side to pass through each of the through holes. As a result, it becomes difficult to see the radiator from the front grille side, and the appearance of the radiator when viewed from the front grille side is improved. In this manner, with the above configuration, it is possible to improve both the appearance of the radiator when viewed from the front grille side of the vehicle and the performance of cooling the radiator.

A height of an upper end of a portion forming an edge on the front side of the through hole may be equal to or greater than a height of a lower end of a portion forming an edge on the rear side of the through hole. With this configuration, the line of sight from a higher position can be blocked by the front cover member, and the appearance of the radiator can be improved.

According to the present disclosure, it is possible to improve both the appearance of the radiator when viewed from the front grille side of the vehicle and the performance of cooling the radiator.

### BRIEF DESCRIPTION OF THE DRAWINGS

Embodiments of the present disclosure will be described based on the following figures, wherein:

FIG. 1 is a perspective view illustrating a radiator support upper cover;

FIG. 2 is a cross-sectional view taken along line A-A of FIG. 1;

FIG. 3 is an enlarged view of FIG. 2; and

FIG. 4 is a cross-sectional view illustrating a radiator support upper cover according to a modification example.

### DESCRIPTION OF EMBODIMENTS

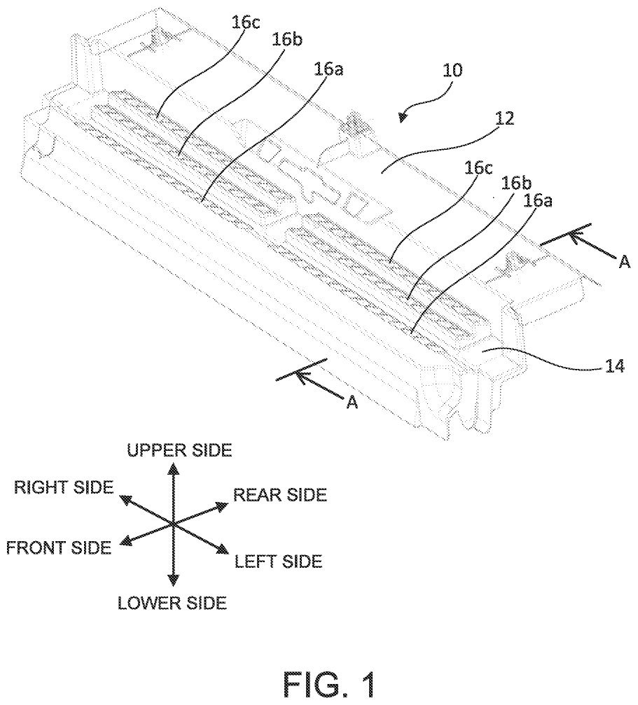

A radiator support upper cover 10 according to an embodiment will be described with reference to FIG. 1. FIG. 1 is a perspective view illustrating the radiator support upper cover 10. In FIG. 1, the front side of the vehicle, the rear side of the vehicle, the right side of the vehicle, the left side of the vehicle, the upper side of the vehicle, and the lower side of the vehicle are indicated by directions of arrows, respectively.

The radiator support upper cover 10 is a member that covers the upper portion of a radiator provided in a vehicle. The radiator support upper cover 10 includes an upper cover member 12 and a front cover member 14.

The upper cover member 12 and the front cover member 14 are panel-shaped members extending in the right-left direction of the vehicle. The front cover member 14 is a member extending obliquely to the lower side from the upper cover member 12 toward the front side of the vehicle.

The front cover member 14 is provided with a plurality of through holes 16a, a plurality of through holes 16b, and a plurality of through holes 16c. Each of the through holes 16a, 16b, and 16c is a through hole for guiding air and penetrating the front cover member 14 in the up-down direction of the vehicle. The shape of each of the through holes 16a, 16b, and 16c is a circular shape, a rectangular shape, an elongated slit-like shape, or the like.

The plurality of through holes 16a are arranged in a row along the right-left direction of the vehicle and formed on the front side of the front cover member 14. The plurality of through holes 16b are arranged in a row along the right-left direction of the vehicle and formed at the center of the front cover member 14. The plurality of through holes 16c are arranged in a row along the right-left direction of the vehicle and formed on the rear side of the front cover member 14.

Each of the through holes 16a is formed at a position on the front side in the front cover member 14. Each of the through holes 16c is formed at a position on the rear side in the front cover member 14. Each of the through holes 16b is formed between the through hole 16a and the through hole 16c. That is, the through holes 16a, 16b, and 16c are formed to be arranged in the front cover member 14 in the order of the through holes 16a, 16b, and 16c from the front side to the rear side of the front cover member 14.

Also, the plurality of through holes located on the rear side are formed at positions further on the upper side in the up-down direction of the vehicle (that is, higher positions) than the plurality of through holes located on the front side. Specifically, the through holes 16b are formed at positions further on the upper side than the through holes 16a, and the through holes 16c are formed at a position further on the upper side than the through holes 16b. For example, the front cover member 14 is formed in a stepped shape so as to be higher from the front side to the rear side of the vehicle. The plurality of through holes 16a are formed on the first stage, which is the lowest, the plurality of through holes 16b are formed on the second stage, which is the middle stage, and the plurality of through holes 16c are formed on the third stage, which is the highest.

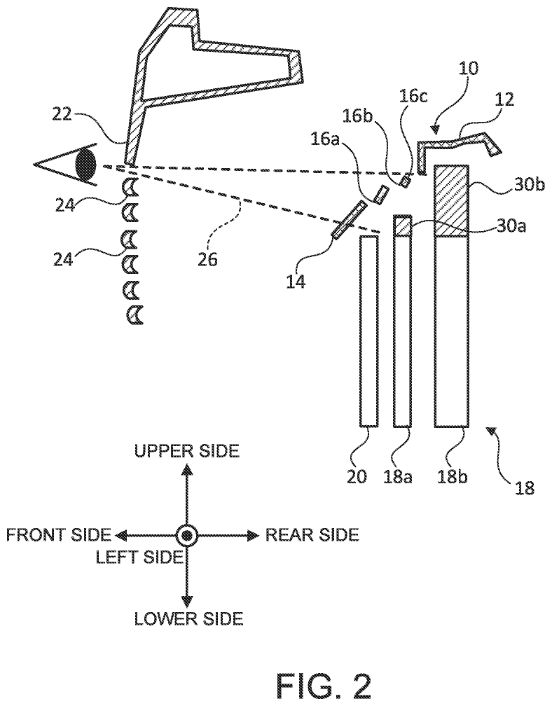

A positional relationship among the radiator support upper cover 10, a radiator 18, and a front grille 22 will be described with reference to FIG. 2. FIG. 2 is a cross-sectional view taken along line A-A of FIG. 1. FIG. 2 illustrates the radiator support upper cover 10, the radiator 18, and the front grille 22.

An engine compartment in which an engine is mounted is formed in the front body of the vehicle, and the radiator 18 that cools the engine is mounted in the engine compartment. The radiator 18 includes, for example, a low temperature (LT) radiator 18a and a high temperature (HT) radiator 18b. The LT radiator 18a is provided further on the front side of the vehicle than the HT radiator 18b. The HT radiator 18b extends to a higher position than the LT radiator 18a. An A/C capacitor 20 is provided on the front side of the LT radiator 18a.

A not-illustrated front bumper is provided at the front end portion of the vehicle. The front bumper is a member extending in the right-left direction of the vehicle. The front grille 22 is provided at the center of the front bumper. The front grille 22 has a plurality of openings 24. Each of the openings 24 is an outside air introduction port for taking outside air into the engine compartment.

The radiator support upper cover 10 is provided over the upper portion of the radiator 18 so as to cover the upper portion of the radiator 18. Specifically, the upper cover member 12 covers a part of the upper portion of the radiator 18. The front cover member 14 covers a part of the upper portion of the radiator 18 and the front portion of the upper portion of the radiator 18. For example, the upper cover member 12 covers the upper portion of the HT radiator 18b. The front cover member 14 extends obliquely to the lower side from the upper cover member 12 toward the front side of the vehicle, and covers the upper portion of the LT radiator 18a, the front portion of the upper portion of the LT radiator 18a, and the front portion of the upper portion of the HT radiator 18b. The front cover member 14 is disposed further on the front side than the radiator 18 so as to cover the front portion of the upper portion of the radiator 18. The front cover member 14 may cover the upper portion of the A/C capacitor 20.

Outside air is taken into the engine compartment from each of the openings 24 of the front grille 22. The outside air taken in is supplied to the radiator 18 through the plurality of through holes 16a, 16b, and 16c formed in the radiator support upper cover 10. As a result, the radiator 18 is cooled.

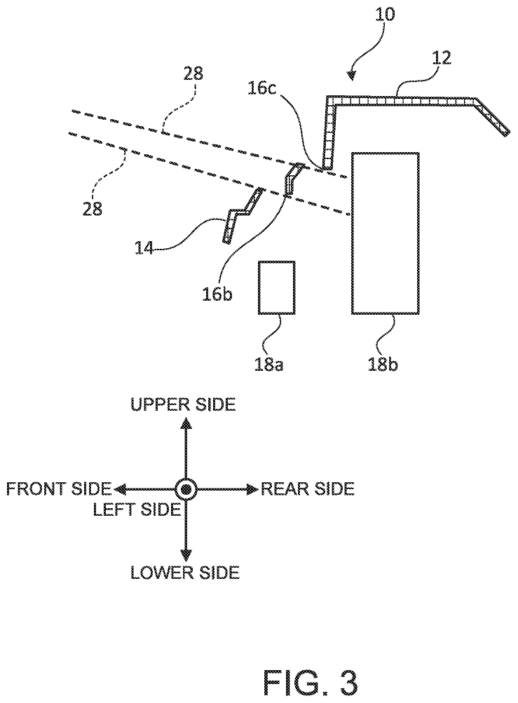

Also, the front portion of the upper portion of the radiator 18 is covered with the front cover member 14. The front cover member 14 functions as a covering portion. This makes it difficult to see the radiator 18 through the openings 24 of the front grille 22. This point will be described below with reference to FIGS. 2 and 3. FIG. 3 is an enlarged view of a part of the configuration illustrated in FIG. 2.

In FIG. 2, a field of view 26 of a person outside the vehicle is indicated by a broken line. The field of view 26 is a range that can be seen from the outside of the vehicle through the openings 24 of the front grille 22. In FIG. 3, a line of sight 28 through the openings 24 is indicated by a broken line.

If the radiator support upper cover 10 is not provided, an upper portion 30a (hatched portion in FIG. 2) of the LT radiator 18a and an upper portion 30b (hatched portion in FIG. 2) of the HT radiator 18b are included in the field of view 26. Therefore, the upper portions 30a and 30b can be seen from the outside of the vehicle. For example, the color of the LT radiator 18a and the color of the HT radiator 18b are silver, and if the silver objects are seen from the outside of the vehicle, the appearance of the radiator 18 is deteriorated.

On the other hand, in the present embodiment, the front portion of the upper portion of the radiator 18 is covered with the front cover member 14. The line of sight through the openings 24 of the front grille 22 is blocked by the front cover member 14. Therefore, the upper portions 30a and 30b are difficult to see from the outside of the vehicle.

The front cover member 14 has the plurality of through holes 16a, 16b, and 16c, and the through holes 16a, 16b, and 16c penetrate the front cover member 14 in the up-down direction of the vehicle and face in the up-down direction. Also, the front cover member 14 is formed in a stepped shape from the front side to the rear side of the vehicle, and the through holes on the rear side are formed at positions further on the upper side than the through holes on the front side. Therefore, the line of sight through the openings 24 hardly passes through the through holes 16a, 16b, and 16c, and the upper portions 30a and 30b are hardly seen from the outside of the vehicle. Since the upper portions 30a and 30b are difficult to see through the openings 24 of the front grille 22, the appearance of the radiator 18 from the side provided with the front grille 22 is improved.

As described above, the radiator support upper cover 10 according to the present embodiment can improve the appearance of the radiator 18 from the side provided with the front grille 22. In addition, since the outside air can be supplied to the radiator 18 through the plurality of through holes 16a, 16b, and 16c, the air guide to the radiator 18 is secured. In this manner, it is possible to improve both the appearance of the radiator 18 and the performance of cooling the radiator 18.

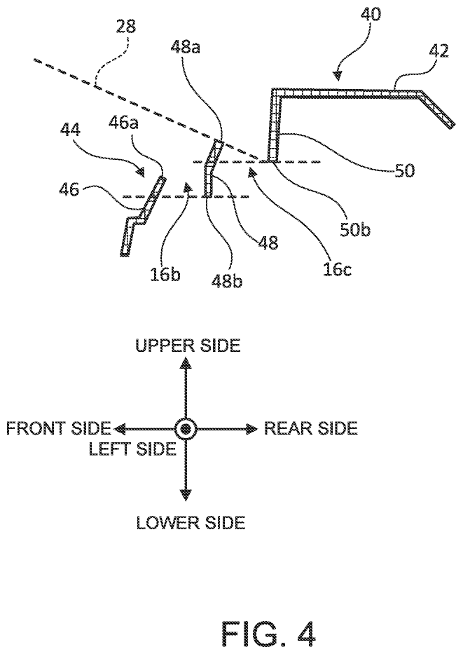

Hereinbelow, a radiator support upper cover 40 according to a modification example will be described with reference to FIG. 4. FIG. 4 is a cross-sectional view illustrating the radiator support upper cover 40.

The radiator support upper cover 40 includes an upper cover member 42 and a front cover member 44, and is provided so as to cover the upper portion of the radiator 18, similarly to the radiator support upper cover 10. Similarly to the upper cover member 12, the upper cover member 42 covers a part of the upper portion of the radiator 18 (for example, the upper portion of the HT radiator 18b). Similarly to the front cover member 14, the front cover member 44 is a member extending obliquely to the lower side from the upper cover member 42 toward the front side of the vehicle, and is disposed further on the front side than the radiator 18 so as to cover the front portion of the upper portion of the radiator 18. Similarly to the front cover member 14, the front cover member 44 is provided with the plurality of through holes 16a, 16b, and 16c. The positional relationship among the plurality of through holes 16a, 16b, and 16c formed in the front cover member 44 is the same as the positional relationship among the plurality of through holes 16a, 16b, and 16c formed in the front cover member 14.

In the modification example, as for each of the through holes, the height of the upper end of the portion forming the edge on the front side of the through hole is equal to or greater than the height of the lower end of the portion forming the edge on the rear side of the through hole.

For example, the height of an upper end 46a of a portion 46 forming the edge on the front side of the through hole 16b is equal to or greater than the height of a lower end 48b of a portion 48 forming the edge on the rear side of the through hole 16b. In the example illustrated in FIG. 4, the height of the upper end 46a is higher than the height of the lower end 48b. That is, the upper end 46a is disposed further on the upper side than the lower end 48b.

Similarly, the height of an upper end 48a of a portion 48 forming the edge on the front side of the through hole 16c is equal to or greater than the height of a lower end 50b of a portion 50 forming the edge on the rear side of the through hole 16c. In the example illustrated in FIG. 4, the height of the upper end 48a is higher than the height of the lower end 50b. That is, the upper end 48a is disposed further on the upper side than the lower end 50b.

By using the front cover member 44 having the above configuration, the line of sight 28 from the upper side can be blocked by the front cover member 44. For example, even in a case where the openings 24 of the front grille 22 are formed at higher positions and the radiator 18 is looked at downward through the openings 24, the line of sight 28 is blocked by the front cover member 44. Since it is difficult to see the radiator 18 through the openings 24, the appearance of the radiator 18 is improved. Also, similarly to the case of the radiator support upper cover 10, the outside air can be supplied to the radiator 18 through the through holes 16a, 16b, and 16c to cool the radiator 18.

1. A radiator support upper cover that covers an upper portion of a radiator, the radiator support upper cover comprising:
a front cover member that covers a portion of the upper portion of the radiator on a vehicle front side,
wherein the front cover member is provided with a plurality of through holes penetrating the front cover member in a vehicle up-down direction,
wherein the plurality of through holes are formed to be arranged from the vehicle front side to a vehicle rear side, and
wherein a through hole located on the vehicle rear side among the plurality of through holes is formed at a position further on an upper side in the vehicle up-down direction than a through hole located on the vehicle front side among the plurality of through holes.

2. The radiator support upper cover according to claim 1, wherein
a height of an upper end of a portion forming an edge on the vehicle front side of the through hole is equal to or greater than a height of a lower end of a portion forming an edge on the vehicle rear side of the through hole.
